(19) United States
(12) Patent Application Publication
(10) Pub. No.: US 2010/0226599 A1
(43) Pub. Date: Sep. 9, 2010

(54) Fastener Tape and Packaging Bag with Fastener Tape

(76) Inventors: Ryo Katada, Chiba (JP); Kenichi Tanaka, Chiba (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/599,633

(22) PCT Filed: May 7, 2008
(86) PCT No.: PCT/JP2008/058478

§ 371 Date: Nov. 10, 2009

(30) Foreign Application Priority Data
May 10, 2007 (JP) 2007-125865

(51) Int. Cl. B65D 33/00; B32B 1/02

(52) U.S. Cl. 383/210; 428/35.2

(57) ABSTRACT

A fastener tape (1) includes a belt-shaped male member (11) on one side and a female member (12) to be engaged with the male member (11) on the other side. The male member (11) includes a belt-shaped base (111) welded to a bag body (20), and the female member (12) also includes a belt-shaped base (121) welded to the bag body (20). The wider belt-shaped base (121) provides a seal base (13) at a portion that is wider than the belt-shaped base (111). A peeling layer (14) and seal layer (15) are layered on a surface (13B) of the seal base (13) on a side of an engagement portion (10), so that the seal layer (15) is sealed to the opposing inner surface of the bag body (20) to provide a seal portion (16).

### TECHNICAL FIELD

The present invention relates to an openable and resealable fastener tape attached to a packaging bag, and the packaging bag attached with the fastener tape.

### BACKGROUND ART

As packaging materials for packaging various articles such as foods, pharmaceutical and medical products and groceries, packaging bags with fastener tapes are known. In such a packaging bag, a fastener tape including a pair of a belt-shaped male member and female member that are engageable with each other is attached to an opening of the packaging bag so that the packaging bag is openable and resealable.

In such a packaging bag with a fastener tape, a tape portion of the fastener tape is widened toward the content, and the widened portion is partially provided with an easy-peel portion. By sealing the fastener tape to the opposing film, the content is prevented from adhering to the fastener tape. When the content is to be taken out, the easy-peel portion is peeled, so that the content is taken out (e.g., Patent Document 1).

On the other hand, according to other known configurations, some bags for containing liquid content have their liquid inlet provided by fastener tapes, and other bags for containing liquid content have heat-sealed seal portions at positions outward of the fastener tapes, so that the heat-sealed portions are to be cut off in use with scissors. However, the bag of which the liquid inlet is provided only by the fastener tape exhibits reduced sealing performance, and the quality of the content may be affected. In addition, since it is difficult to apply a virgin proof to such a bag, a content side of the fastener tape is sealed.

For instance, according to Patent Document 2, a liquid-containing bag attached with a fastener tape in an openable and closable manner includes an easily-peelable partition provided closer to a content side of the fastener tape, so that the partition prevents the liquid from moving toward the fastener tape before use. In use, the partition is easily peelable with a force to open and close the fastener tape.

Patent Document 1: WO2004/050487

Patent Document 2: JP-A-2005-40630

### DISCLOSURE OF THE INVENTION

### Problems to Be Solved by the Invention

However, the easy-peel layer disclosed in Patent Document 1 is not clearly described in terms of its components. Depending on combinations of layer components, a remnant (typically known as splinter) may be left on the peeling surface, and such a remnant may be mixed into the content.

In addition, according to Patent Document 2, while air-tightness can be ensured, the seal portion of the partition wall requires such a wide area that the dimension of the bag is restricted. When the partition wall is narrowed and a pressure is applied to the bag internally or externally, the partition wall is easily peeled off. Thus, bags with such narrowed partition walls are difficult to use under conditions where hermetic sealing is required. Thus, such bags are hardly usable as packaging bags to be applied with internal pressure in treatment such as heat treatment and retort treatment.

An object of the invention is to provide a sanitary fastener tape and packaging bag with the fastener tape capable of: maintaining sealing performance even when pressure is internally or externally applied to the bag; and being easily unsealed when opened.

### Means for Solving the Problems

In order to attain such an object, a fastener tape according to an aspect of the invention is attached to an inner surface of a bag body of a packaging bag, and includes: an engagement portion; a pair of a male member and a female member, the male member and the female member respectively comprising belt-shaped bases continuously connected to the engagement portion; a first belt-shaped base of the belt-shaped bases including a seal base of which a width dimension from the engagement portion to a crosswise end of the first belt-shaped base is larger than a width dimension of a second belt-shaped base of the belt-shaped bases; a peeling layer and a seal layer being layered on a surface of the seal base on a side of the engagement portion, the seal layer being bonded to the seal base via the peeling layer; and the seal base being formed of linear low density polyethylene (LLDPE), the peeling layer being formed of random polypropylene (RPP), the sealing layer being formed of low density polyethylene (LDPE).

In the aspect of the invention, the crosswise end of the belt-shaped base means an end of the belt-shaped base that follows a direction in which the engagement portion extends (continues). Thus, the width dimension from the engagement portion to the crosswise end of the belt-shaped base is a dimension in a direction orthogonal to the extension direction of the engagement portion.

When, for instance, the fastener tape is attached to the inner surface of the film (bag body) forming the packaging bag, the crosswise end of the belt-shaped base is the end located closer to the inner side of the bag body (i.e., where the content is contained) than the engagement portion is, and the width dimension from the engagement portion to the crosswise end of the belt-shaped base is the dimension in the direction from the engagement portion toward the inner side of the bag body.

In the fastener tape according to the aspect of the invention, the first belt-shaped base of the belt-shaped bases continuously connected to the engagement portion is provided with the seal base on the content side, and the peeling layer and the seal layer are layered on the seal base in this order.

When the fastener tape is attached to the packaging bag, the seal layer and the inner surface (sealant) of the packaging bag are sealed to provide the seal portion. The seal portion borders between the engagement-portion side and content side of the packaging bag.

The seal base of the fastener tape is formed of LLDPE, peeling layer is formed of RPP and sealant layer is formed of LDPE. The RPP is favorably compatible with the LLDPE and establishes adhesion thereto, but not as compatible with the LDPE as with the LLDPE. Thus, when the packaging bag is opened, the peeling takes place between the RPP and the LDPE, i.e., between the peeling layer and the seal layer.

Further, the LDPE of the seal layer is favorably compatible with the LLDPE for forming the inner surface (sealant) of the packaging bag, so that the seal layer does not peel off from the sealant after the seal layer and the sealant are sealed.

In other words, with the layer configuration of the seal base, peeling layer, seal layer and sealant, the peeling can selectively take place between the peeling layer and the seal layer (i.e., where the adhesion force is minimized), and users can sense better peelability. Accordingly, the peeling position can be stabilized, and users can stably and reliably open the packaging bag.

In addition, the peeling surfaces at which the peeling layer and seal layer are peeled are clean and free of remnant. Thus, there is hardly a risk that any remnant may be mixed in the content, and the packaging bag is sanitary.

Preferably in the aspect of the invention, the peeling layer is covered in the seal base and the seal layer.

According to the aspect of the invention, the seal layer is bonded to the seal base at its end while covering the peeling layer, so that the peeling layer is not externally exposed.

Thus, when, for instance, the content in the packaging bag is subjected to retort treatment, the seal layer can prevent the content from reaching the peeling layer. Accordingly, reduction in strength of peeling layer can be prevented.

Also preferably in the aspect of the invention, a thickness of the seal layer is 10 μm to 30 μm.

According to the aspect of the invention, with the thickness of the seal layer being 10 μm to 30 μm, the easy-openability of the packaging bag can be enhanced.

When the thickness of the seal layer is less than 10 μm, the excessively small thickness may lead to reduction in sealing strength. On the other hand, when the thickness of the seal layer is more than 30 μm, the peelability may be deteriorated and easy openability may also be lost.

A packaging bag with a fastener tape according to another aspect of the invention is a packaging bag includes: opposing plastic films; the above-described fastener tape welded to opposing inner surfaces of the films so that the seal base is located closer to a content than the engagement portion;

a surface of the seal layer layered on the seal base being sealed to one of the opposing inner surfaces of the films; and a surface of the seal base opposite to the engagement portion being substantially not bonded to the other one of the opposing inner surfaces of the films.

According to the aspect of the invention, the fastener tape is attached so that the seal base becomes a free end, and the surface of the seal base on the side of the engagement portion is sealed to the sealant of the packaging bag via the peeling layer and the seal layer. On the other hand, the surface of the seal base opposite to the engagement portion is substantially not bonded to the opposing sealant of the packaging bag. In other words, the seal base as a free end is sealed to the opposing film of the packaging bag only at the surface on the side of the engagement portion.

Thus, even when pressure is applied internally or externally on the packaging bag, no stress is applied on the engagement portion, thereby preventing peeling of the easy-peel portion and disengagement of the engagement portion. Accordingly, it is possible to provide a packaging bag with a fastener tape having excellent sealing performance.

Herein, “substantially not bonded” is a concept that encompasses a configuration where only a small portion of the surface of the seal base opposite to the engagement portion is intentionally bonded to the opposing sealant of the packaging bag and also a configuration where the surface of the seal base opposite to the engagement portion is intentionally bonded to the opposing sealant with only a small adhesion strength, as long as advantages of the invention are not impaired.

### BRIEF DESCRIPTION OF DRAWINGS

FIG. 1 shows a cross section of a fastener tape according to an exemplary embodiment of the invention.

FIG. 2 is a front view showing a packaging bag with the fastener tape according to the exemplary embodiment of the invention.

FIG. 3 shows a cross section taken along III-III line in FIG. 2.

FIG. 4 shows the packaging bag with the fastener tape when opened in FIG. 3.

### BEST MODE FOR CARRYING OUT THE INVENTION

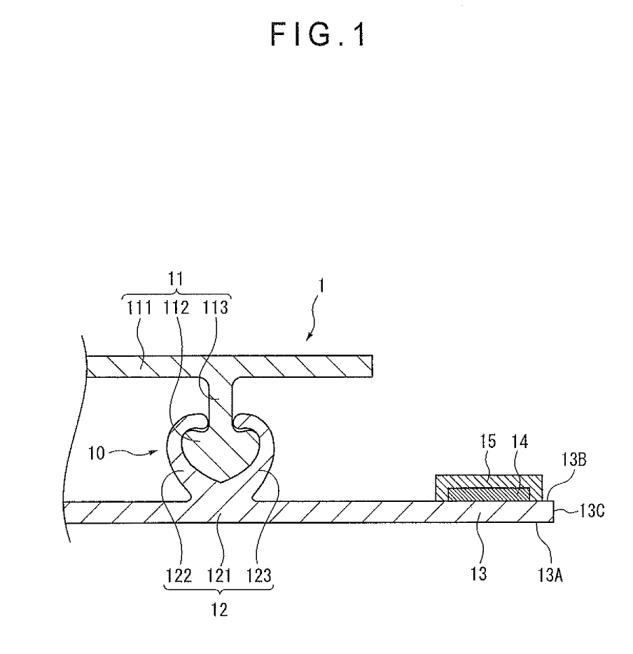

First of all, the configuration of a fastener tape according to an exemplary embodiment of the invention will be described with reference to FIG. 1. FIG. 1 is a cross sectional view showing the fastener tape according to the exemplary embodiment of the invention.

The fastener tape 1 shown in FIG. 1 includes a belt-shaped male member 11 on one side and a female member 12 to be engaged with the male member 11 on the other side.

The male member 11 includes a belt-shaped base 111 welded to the later-described bag body 20, a head 112 shaped substantially in mushroom in cross section and a connecting portion 113 for connecting the belt-shaped base 111 and the head 112, with which the male member 11 is integrally formed.

Similarly to the above-described male member 11, the female member 12 includes a belt-shaped base 121 welded to the later-described bag body 20 and a first hook portion 122 and a second hook portion 123 that are each arcuately shaped in cross section and continued from the belt-shaped base 121. The first and second hooks 122 and 123 face each other.

In the fastener tape 1, the head 112 of the male member 11 and the first and second hooks 122, 123 of the female member 12 provide the engaging portion 10, engaging or releasing of which opens or reseals the packaging bag.

Of the belt-shaped bases 111 and 121 integrated with the male member 11 and the female member 12, the belt-shaped base 121 integrated with the female member 12 has a larger width than the belt-shaped base 111 integrated with the male member 11. Specifically, the wider belt-shaped base 121 provides a seal base 13 at a portion that is wider than the belt-shaped base 111 (i.e., a portion that extends from the engagement portion 10 to a crosswise end 13C of the belt-like base and exhibits a larger width).

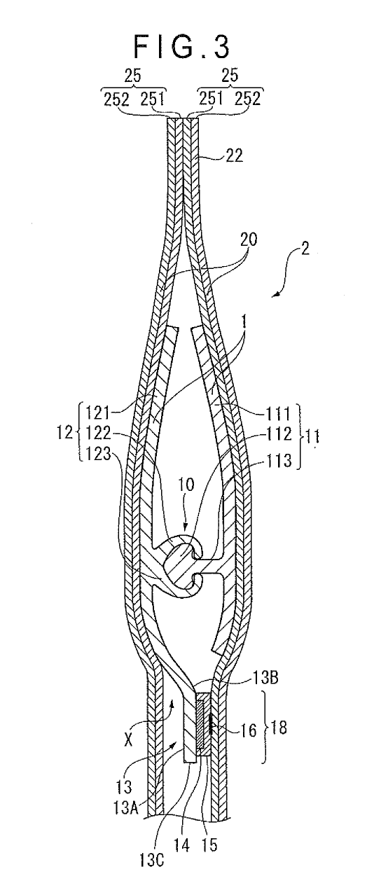

As will be described later, a peeling layer 14 and seal layer 15 are layered on a surface 13B of the seal base 13 on a side of the engagement portion 10, so that the seal layer 15 is sealed to the opposing inner surface of the bag body 20 to provide a seal portion 16 (see FIG. 3).

The male member 11 of the fastener tape 1 according to this exemplary embodiment is obtainable by integrating the head 112 and connecting portion 113 continued from the belt-shaped base 111 by coextrusion forming. Likewise, the female member 12 is also obtainable by integrating the first hook portion 122 and second hook portion 123 continued from the belt-shaped base 121 by coextrusion forming. When the fastener tape 1 is formed by such coextrusion forming, the tape 1 can be manufactured in a simplified process at low cost, and the fastener tape 1 can be stably manufactured in a continuous manner.

For the male member 11 and female member 12 of the fastener tape 1, a thermoplastic resin such as linear low-density polyethylene (LLDPE) may be used.

The peeling layer 14 is formed of polypropylene. The polypropylene may be exemplarily random polypropylene (RPP).

The seal layer 15 is formed of low-density polyethylene (LDPE).

The seal layer 15 preferably has a thickness of 10 to 30 μm. The thinner the seal layer 15 is, the easier it becomes to open the bag. The thicker the seal layer 15 is, the more hermetic a sealing can be established. When the thickness of the seal layer 15 is less than 10 μm, hermetic sealing will not be obtained. When the thickness of the seal layer 15 is more than 30 μm, the bag will not be easily opened. Thus, the thickness of the seal layer 15 is exemplarily 20 μm in this exemplary embodiment.

The peeling layer 14 and seal layer 15 may be formed by coextruding material resins of the peeling layer 14 and seal layer 15 by multilayer coextrusion forming at the time of, for instance, manufacturing the fastener tape 1 by extrusion forming. Alternatively, the engagement portion 10 and belt-shaped bases 111 and 121 of the fastener tape 1 may be formed by extrusion in advance, and then the peeling layer 14 and seal layer 15 may be sequentially layered by extrusion on the surface 13B of the seal base 13 on the side of the engagement portion 10.

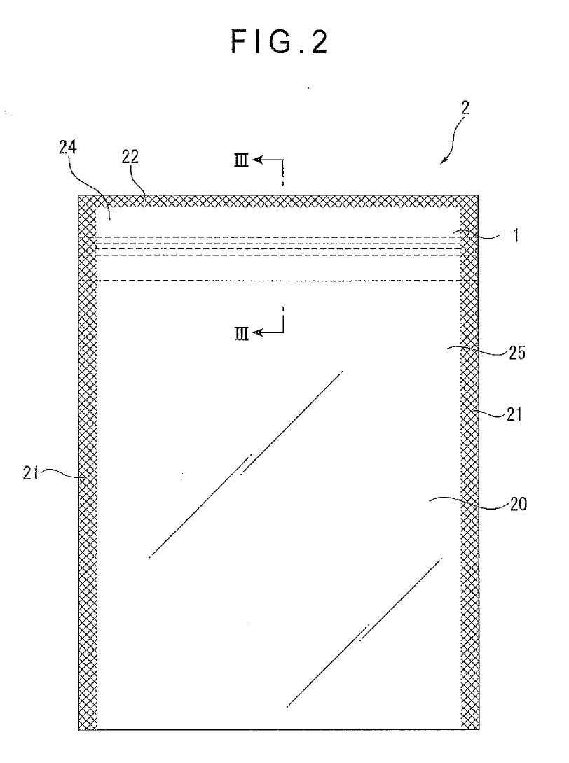

Next, a packaging bag 2 having a fastener tape, in which the fastener tape 1 is attached to the bag body 20, will be described with reference to FIGS. 2 and 3.

FIG. 2 is a front view showing a packaging bag with the fastener tape according to the exemplary embodiment of the invention. FIG. 3 shows a cross section taken along III-III line in FIG. 2.

As shown in FIGS. 2 and 3, the packaging bag 2 with the fastener tape includes the bag body 20 provided by laying base films 25 (packing material) one on the other and forming a side seal portion 21 on the periphery thereof. The fastener tape 1, which includes the pair of male member 11 and female member 12 including the engagement portion 10 and the belt-shaped portions 111 and 121 continuously connected to the engagement portion 10, is attached to the inner surface of an opening portion 24 of the bag body 20.

By heat-sealing surfaces of the belt-shaped bases 111 and 121 opposite to the engagement portion 10 to the opposing inner surface of the bag body 20, the fastener tape 1 is fixed to the bag body 20. However, the belt-shaped base 121 integrated with the female member 12 is substantially not bonded to the opposing inner surface of the bag body 20 at a surface 13A of the seal base 13 opposite to the engagement portion 10.

On the other hand, the peeling layer 14 and seal layer 15, which are layered on the seal base 13 of the belt-shaped base 121 integrated with the female member 12 on the side of the engagement portion 10, are sealed to a sealant layer 251 of the base film 25 of the bag body 20 opposing to the seal layer 15, thereby providing the seal portion 16. The seal base 13, peeling layer 14, seal layer 15 and seal portion 16 are collectively referred to as an easy-peel portion 18.

The seal portion 16 is provided by unilaterally sealing the opposing base film 25 of the bag body 20 with use of a seal bar (not shown). At this time, by raising the edge of the seal bar, the thickness of the seal layer 15 can be reduced. The thinner the seal layer 15, which abuts on the seal portion 16, becomes, the easier it becomes to open the bag. Thus, the edge of the seal bar may be adjusted as needed for different uses.

The easy-peel portion 18 is bonded in an easily peelable manner. Specifically, the surface 13B of the seal base 13 (the surface on the side of the engagement portion 10) and the sealant layer 251 of the base film 25 (the layer forming the opposing inner surface of the bag body 20) are bonded together to such a degree that the surface 13B and the sealant layer 251 are separable via the peeling layer 14 and seal layer 15 with moderate force. Peeling strength for both of the above is preferably approximately 1 to 20N/15 mm width.

Incidentally, after a content (not shown) is packed through a bottom of the bag body 2, the bottom side of the packaging body 20 is sealed to provide a hermetically-sealed space.

In use, a user cuts the opening portion 24 to open the package, and reseals the package with the fastener tape 1.

While the base film 25 (packaging material) for forming the bag body 20 is preferably a layered film in which the sealant layer 251 is layered onto a base layer 252, the base film 25 may be a layered film in which a layered film layer (not shown) including layers of a gas barrier layer, a light-shielding layer and a strength-reinforcing layer is provided as a middle layer between the base layer 252 and the sealant layer 251, depending on a required performance.

Examples of the material for the base layer 252 are preferably a biaxially-oriented polypropylene film (OPP film), a biaxially-oriented polyester film such as biaxially-oriented polyethylene terephthalate film (PET film) and biaxially-oriented polyethylene naphthalate film (PEN film) and a biaxially-oriented polyamide film such as nylon 6, nylon 66 and MXD6 (poly meta xylylene adipamide). Depending on needs, various engineering plastic films are also usable. One of the above may be singularly used, or a combination of two or more of the above may be layered in use.

When the middle layer is a gas barrier layer, usable examples of the material for the middle layer are a film of saponified ethylene-vinyl acetate copolymer (EVOH), polyvinylidene chloride (PVDC) or polyacrylonitrile (PAN), aluminum foil, a deposited layer of silica, alumina or aluminum and a coating layer of PVDC.

When a deposited layer of silica, alumina or aluminum or a coating layer of PVDC is used, such a layer may be deposited or applied on the inner surface of the base layer 252. Alternatively, such a layer may be preliminarily deposited or applied on another biaxially-oriented nylon film (ONy film), biaxially-oriented polyethylene terephthalate film (PET film) or biaxially-oriented polypropylene film (OPP film), and the film may be layered on the middle layer.

Among the above, aluminum foil and a deposited layer of aluminum, which are opaque, can also serve as a light-shielding layer.

The layering of the base layer 252 and the films of the middle layer can be conducted by a known dry lamination method or extrusion lamination method (sandwich lamination method).

For the sealant layer 251 (the innermost layer), linear low density polyethylene (LLDPE) and low density polyethylene (LDPE) may be used.

In order to layer the sealant layer 251, the above resins may be formed into films and layered by a dry lamination method or extrusion lamination method. Alternatively, the above resins may be layered thereon by extrusion coating.

In this exemplary embodiment, the peeling is to selectively take place between the peeling layer 14 and the seal layer 15 of the fastener tape 1. Thus, the selection of the resins is made so that the peeling strength between the peeling layer 14 and the seal layer 15 is smaller than the peeling strength between the seal base 13 and the peeling layer 14 and than the peeling strength between the seal layer 15 and the sealant layer 251. As the combination of the resins that satisfies the above-described relationship, LLDPE is used for the seal base 13, RPP is used for the peeling layer 14, LDPE is used for the seal layer 15 and LLDPE is used for the sealant layer 215 in this exemplary embodiment. Accordingly, the combination of the resins for the peeling layer 14, seal layer 15 and sealant layer 251 can realize the suitable selection.

The packaging bag 2 with the fastener tape according to the aspect of the invention can be easily manufactured with use of, for instance, a commercially-available bag making machine for three-sided sealing and attaching a fastener tape.

Welding conditions (temperature, pressure, etc.) in the manufacturing can be properly determined in accordance with types of the resins for forming the fastener tape 1 and the base film 25 for forming the bag body 20.

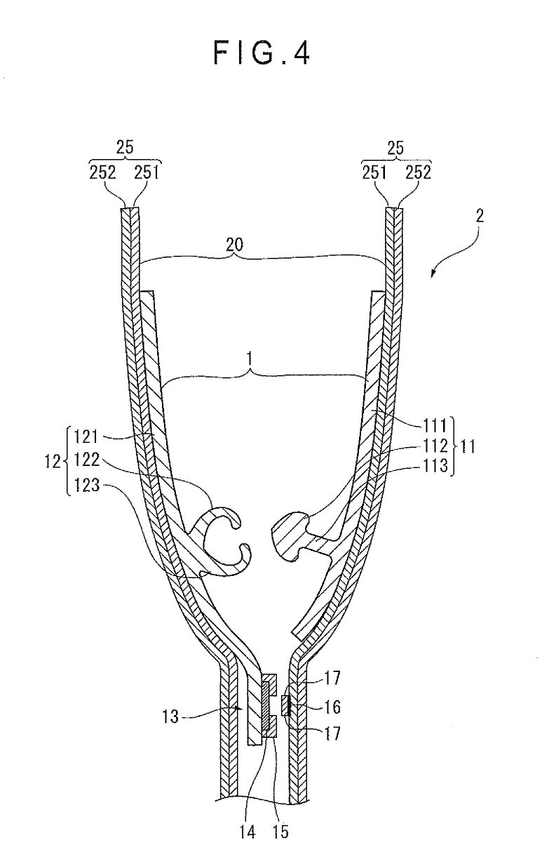

Next, description will be made on how the packaging bag 2 with the fastener tape of this exemplary embodiment is opened with reference to FIGS. 3 and 4.

In FIG. 3, the male member 11 and the female member 12 of the fastener tape 1 are in engagement with each other. In this engagement, at the lower side of the engagement portion 10 (i.e., content side) in FIG. 3, the surface 13B of the seal base 13 (surface on the side of the engagement portion 10) on the belt-shaped base 121 of the female member 12, which is wider than the belt-shaped base 111 of the male member 11, is bonded to the opposing inner surface of the bag body 20 in an easily peelable manner. This arrangement can maintain air-tightness and water-tightness of the bag, and prevent liquid content from infiltrating into a gap in the engagement portion 10 of the fastener tape 1 during, for instance, transportation.

In the packaging bag 2 with the fastener tape shown in FIG. 3, the surface 13A of the seal base 13 opposite to the engagement portion 10 is substantially not bonded to the opposing inner surface of the bag body 20. Thus, even when an internal pressure is applied to the bag body 20 on the content side exemplarily due to retort processing, the stress concentrates on the portion indicated by “X” in FIG. 3. Accordingly, the surface 13B of the seal base 13 on the side of the engagement portion 10 does not peel off from the opposing inner surface of the bag body 20 due to the application of the internal pressure, and leakage of the content can be prevented.

When the content is to be taken out from the packaging bag 2 with the fastener tape, the opening portion 24 shown in FIG. 2 is cut off, and the engagement of the engagement portion 10 is canceled by opening the fastener tape 1 as shown in FIG. 4 (FIG. 4 where the engagement is canceled does not specifically show the engagement portion 10). When the upper side of the bag body 20 (i.e., side opposite to the content side) is further opened, the seal layer 15 starts to be ruptured at both ends of the seal portion 16 with the opening force, and a rupture portion 17 is formed. When the rupture portion 17 reaches the peeling layer 14, the peeling takes place between the peeling layer 14 and the seal layer 15, thereby opening the packaging bag 2 with the fastener tape.

The above-described exemplary embodiment can provide the following advantages.

(1) The easy-peel portion 18 is provided by layering the peeling layer 14 and the seal layer 15 onto the seal base 13. LLDPE is used for the seal base 13, RPP is used for the peeling layer 14, LDPE is used for the seal layer 15 and LLDPE is used for the sealant layer 251 to be sealed with the seal layer 15. Compatibility between the LLDPE of the seal base 13 and the RPP of the peeling layer 14 and compatibility between the LDPE of the seal layer 15 and the LLDPE of the sealant layer 251 are favorable, thereby establishing adhesion to each other. In contrast, the compatibility between the RPP of the peeling layer 14 and the LDPE of the seal layer 15 is comparatively not favorable. In other words, the peeling strength between the peeling layer 14 and the seal layer 15 is the minimum.

In this arrangement, the force applied at the time of opening the packaging bag 2 to cancel the engagement of the engagement portion 10 and open the bag causes delamination between the peeling layer 14 and the seal layer 15. More specifically, the seal layer 15 starts to be ruptured at both ends of the seal portion 16, and when the rupture reaches the peeling layer 14, the delamination takes place between the peeling layer 14 and the seal layer 15 (see FIG. 4).

Accordingly, the combination of the resins used for the respective layers can make the peeling selectively take place between the peeling layer 14 and the seal layer 15, so that the bag can be reliably opened. Hence, the opening position can be stabilized, thereby enhancing easy-openability.

(2) By arranging the easy-peel portion 18 as described above, the peeling layer 14 and the seal layer 15 can exhibit clean peeling surfaces with no remnant when the packaging bag 2 with the fastener tape is opened. Hence, there is hardly a risk that any remnant is mixed into the content, and the packaging bag 2 with the fastener tape is sanitary.
(3) Since the thickness of the seal layer 15 of the easy-peel portion 18 is 20 μm, the packaging bag 2 with the fastener tape is both easily openable and hermetically sealable.
(4) In the packaging bag 2 with the fastener tape according to this exemplary embodiment, the belt-shaped base 121 of the female member 12 is wider in the direction toward the content than the belt-shaped base 111 of the male member 11. The surface 13B of the seal base 13 (i.e., surface on the side of the engagement portion 10) in the wider belt-shaped base 121 of the female member 12 is bonded to the opposing inner surface of the bag body 20 in an easily-peelable manner. This arrangement can maintain air-tightness and water-tightness and prevent liquid content from infiltrating into a gap of the engagement portion 10 of the fastener tape 1.
(5) The surface 13A of the seal base 13 (i.e., surface opposite to the engagement portion 10) on the belt-shaped base 121 of the female member 12 is substantially not bonded to the opposing inner surface of the bag body 20. Thus, even when internal pressure is applied on the bag body 20 on the content side, the surface 13B of the seal base 13 on the side of the engagement portion 10 does not peel off from the opposing inner surface of the bag body 20, and leakage of the content can be prevented.

Accordingly, the packaging bag 2 with the fastener tape arranged as described above is excellent in air-tightness and water-tightness, and also capable of preventing leakage of the content even when an internal pressure is applied to the bag body 20 on the content side. Hence, the packaging bag 2 with the fastener tape is usable for packaging various items such as foods, pharmaceutical and medical products and groceries, and also processable in retort disinfection treatment at high temperature.

It should be noted that the above-described embodiments are only exemplary embodiments of the invention. The invention is not limited to the above-described embodiments but may include such modifications and improvements that are compatible with the invention. Further, the specific arrangements and configurations may be altered in any manner as long as the modifications and improvements are compatible with the invention.

For instance, while the male member 11 and the female member 12 of the fastener tape 1 are configured such that the belt-shaped base 121 of the female member 12 is wider than the belt-shaped base 111 of the male member 11 in the above exemplary embodiment, the configuration is not limited thereto. Alternatively, the belt-shaped base 111 of the male member 11 may be wider than the belt-shaped base 121 of the female member 12, and the seal base may be provided on the belt-shaped base 111.

While the belt-shaped bases 111 and 121 of the male member 11 and the female member 12 are directly heat-sealed to the inner surface (sealant layer 251) of the bag body 20 at the time of attaching the fastener tape 1 to the bag body 20 in the above exemplary embodiment (except for the surface 13A of the seal base 13 opposite to the engagement portion 10 on the belt-shaped base 121 of the female member 12), the belt-shaped bases 111 and 121 of the male member 11 and the female member 12 may be provided with adhesion layers formed of heat-sealable resins. Such adhesion layers can realize favorable attachment of the fastener tape 1 to the bag body 20 (however, no adhesion layer is required to be provided to the surface 13A of the seal base 13 opposite to the engagement portion 10 on the belt-shaped base 121 of the female member 12).

While the fastener tape 1 is opened and resealed by engaging or disengaging the substantially mushroom-shaped head 112 of the male member 11 with or from the substantially arcuate first and second hooks 122 and 123 of the female member 12 (i.e., by engaging or disengaging the engagement portion 10) in the above exemplary embodiment, the shapes of the engagement portion 10 are not limited thereto. As long as openable and resealable, the shapes and the numbers of the head 112 of the male member 11 and the first and second hooks 122 and 123 may be suitably determined.

The specific arrangement, the shape and the like in carrying out the invention may be altered as long as such alternation is compatible with the invention.

### EXAMPLES

Now, the invention will be described in further detail with reference to examples and comparatives. However, the invention is not limited to such examples or the like at all.

With respect to solid properties of resins in the below-described examples and the like, melt flow rates (MFR) were measured based on JIS K7210 (polypropylene and polyethylene were respectively at 230 degrees C. and 190 degrees C. under 21.1N load), and melting points were measured based on JIS K7121.

### Example 1

The fastener tape 1 shaped as shown in FIG. 1 was manufactured by extrusion with a commercially-available extrusion molding machine, and the following materials were used for the seal base 13, peeling layer 14 and seal layer 15. The thickness of the seal layer 15 was 20 μm.

Seal base 13: the LLDPE resin (MFR: 8.0 g/10 minutes, melting point: 123 degrees C.)

Peeling layer 14: the RPP resin (MFR: 6.0 g/10 minutes, melting point: 133 degrees C.)

Seal layer 15: the LDPE resin (MFR: 1.5 g/10 minutes, melting point: 110 degrees C.)

### Comparative 1

Comparative 1 was prepared so that the portion corresponding to the seal layer 15 of Example 1 was 50 μm thick.

### Comparative 2

As Comparative 2, a packaging bag corresponding to a liquid container bag disclosed in Patent Document 1 (JP-2005-40630, related art) was used.

### Comparative 3

A fastener tape in which an adhesion layer and a peeling layer were layered on a surface of a seal base in this order was manufactured. The following materials were used for the seal base and respective layers, and the fastener tape was manufactured by extrusion with a commercially-available extrusion molding machine.

Seal base: the LLDPE resin (MFR: 8.0 g/10 minutes, melting point: 123 degrees C.)

Adhesion layer: mixture of the LLDPE resin and the RPP resin (LLDPE:RPP=60:40)

Peeling layer: mixture of the LLDPE resin and the RPP resin (LLDPE:RPP=40:60)

### Comparative 4

Comparative 4 was prepared in the same manner as Comparative 3 except that the following materials were used for the adhesion layer and the peeling layer.

Adhesion layer: mixture of the LLDPE resin and the RPP resin (LLDPE:RPP=80:20)

Peeling layer: mixture of the LLDPE resin and the RPP resin (LLDPE:RPP=20:80)

### Comparative 5

Comparative 5 was prepared in the same manner as Comparative 3 except that the following materials were used for the adhesion layer and the peeling layer.

Adhesion layer: mixture of the LLDPE resin and the RPP resin (LLDPE:RPP=60:40)

Peeling layer: mixture of the LLDPE resin and the RPP resin (LLDPE:RPP=50:50)

### Comparative 6

Comparative 6 was prepared in the same manner as Comparative 3 except that the following materials were used for the adhesion layer and the peeling layer.

Adhesion layer: mixture of the LLDPE resin and the RPP resin (LLDPE:RPP=80:20)

Peeling layer: mixture of the LLDPE resin and the RPP resin (LLDPE:RPP=60:40)

### Comparative 7

Comparative 7 was prepared in the same manner as Comparative 3 except that the following materials were used for the adhesion layer and the peeling layer.

Adhesion layer: mixture of the LLDPE resin and the RPP resin (LLDPE:RPP=60:40)

Peeling Layer: Mixture of the LLDPE Resin and the RPP Resin (LLDPE:RPP=10:90)

<Test>

A multilayer film formed of biaxially-oriented nylon film (thickness 15 μm)/cast polyethylene film (thickness 80 μm) was formed into a bag with a bag making machine for three-sided sealing. The surface of the seal base opposite to the engagement portion was arranged substantially not to bonded to the opposing inner surface of the multilayer film. The sealing condition for sealing the seal layer or peeling layer to the multilayer film was 160 degrees C.

The packaging bags with the fastener tapes according to Example 1 and Comparatives 1 to 7 were evaluated in terms of peelability, conditions of the peeling surfaces, pressure resistance and drop impact. Evaluation of each item was conducted in the following manner.

<Evaluation Standard for Peelability>

The easy-peel portion was cut into a width of 15 mm, and subjected to a peeling test of 180° peeling (tension strength: 300 mm/minute) with a digital force gauge manufactured by IMADA Seisakusho Co., Ltd. The ratings are as follows.

A: Peelable with suitable peeling strength.

B: Some resistance was felt, but still peelable.

C: Peeling strength was so great that peeling was difficult or impossible. Alternatively, the peeling strength was so small that sealing was not possible.

<Evaluation Standard for Conditions of Peeling Surfaces>

A: No remnant was left on the peeling surfaces.

B: Some remnant was left on the peeling surfaces, but the remnant was not of separable level.

C: Remnant was left on the peeling surfaces, and the remnant was of separable level.

<Evaluation Standard for Pressure Resistance>

The packaging bag with the fastener tape according to each of Example 1 and Comparatives 1 to 7 was filled with 200 ml of water, applied with load of 100 kg and left for a minute. Then, whether or not the easy-peel portion was peeled was checked.

A: Easy-peel portion was not peeled.

C: Easy-peel portion was peeled.

<Evaluation Standard for Drop Impact>

The packaging bag with the fastener tape according to each of Example 1 and Comparatives 1 to 7 was filled with 200 ml of water and dropped from a height of 1 m. Then, whether or not the easy-peel portion was peeled was checked.

A: Easy-peel portion was not peeled.

C: Easy-peel portion was peeled.

Table 1 shows the evaluation results.

TABLE 1

| | | Peeling | Pressure | Drop |
|---|---|---|---|---|
| | Peelability | Surfaces | Resistance | Impact |
| Example 1 | A | A | A | A |
| Comparative 1 | A | A | C | C |
| Comparative 2 | B | C | A | A |
| Comparative 3 | A | B | A | A |
| Comparative 4 | A | B | A | A |
| Comparative 5 | B | C | A | A |
| Comparative 6 | B | B | A | A |
| Comparative 7 | C | A | A | A |

As is understood from Table 1, Example 1 exhibited favorable results in terms of all of the peelability, peeling surfaces, pressure resistance and drop impact.

While exhibiting favorable results in terms of peelability and peeling surfaces, Comparative 1 exhibited unfavorable results in terms of pressure resistance and drop impact.

Comparative 2, of which seal layer was thick, exhibited unfavorable peelability and had a remnant on the peeling surfaces.

Comparatives 3 to 7 each had a different layer arrangement in the easy-peel portion. Although tested by changing the blending ratio of resins in each layer, Comparatives 3 to 7 exhibited an unfavorable result in terms of at least either one of the peelability and peeling surfaces.

1. A fastener tape attached to an inner surface of a bag body of a packaging bag, comprising:
an engagement portion;
a pair of a male member and a female member, the male member and the female member respectively comprising belt-shaped bases continuously connected to the engagement portion;
a first belt-shaped base of the belt-shaped bases comprising a seal base of which a width dimension from the engagement portion to a crosswise end of the first belt-shaped base is larger than a width dimension of a second belt-shaped base of the belt-shaped bases;
a peeling layer and a seal layer being layered on a surface of the seal base on a side of the engagement portion, the seal layer being bonded to the seal base via the peeling layer; and
the seal base being formed of linear low density polyethylene (LLDPE), the peeling layer being formed of random polypropylene (RPP), the sealing layer being formed of low density polyethylene (LDPE).

2. The fastener tape according claim 1, wherein the peeling layer is covered in the seal base and the seal layer.

3. The fastener tape according to (claim 1), wherein a thickness of the seal layer is 10 μm to 30 μm.

4. A packaging bag with a fastener tape, comprising:
opposing plastic films;
the fastener tape according to (claim 1) welded to opposing inner surfaces of the films so that the seal base is located closer to a content than the engagement portion;
a surface of the seal layer layered on the seal base being sealed to one of the opposing inner surfaces of the films; and
a surface of the seal base opposite to the engagement portion being substantially not bonded to the other one of the opposing inner surfaces of the films.

5. The fastener tape according to claim 2, wherein a thickness of the seal layer is 10 μm to 30 μm.
